(19) United States
(12) Patent Application Publication
(10) Pub. No.: US 2025/0056558 A1
(43) Pub. Date: Feb. 13, 2025

(54) METHOD AND APPARATUS FOR DORMANT CELL(S) WITH MULTI-CELL SCHEDULING

(71) Applicant: Apple Inc., Cupertino, CA (US)

(72) Inventors: Ankit BHAMRI, Bad Nauheim (DE); Wei ZENG, Saratoga, CA (US); Haitong SUN, Cupertino, CA (US); Hong HE, San Jose, CA (US); Dawei ZHANG, Saratoga, CA (US); Chunxuan YE, San Diego, CA (US); Chunhai YAO, Beijing (CN)

(73) Assignee: Apple Inc., Cupertino, CA (US)

(21) Appl. No.: 18/668,938

(22) Filed: May 20, 2024

Related U.S. Application Data
(60) Provisional application No. 63/531,726, filed on Aug. 9, 2023.

(51) Int. Cl. H04W 72/232

(52) U.S. Cl. CPC H04W 72/232

(57) ABSTRACT

Some aspects of this disclosure relate to apparatuses and methods for implementing mechanisms for managing dormant cell(s) within a set of cells for multi-cell scheduling. For example, a UE can be configured to receive information associated with a set of cells for multi-cell scheduling and determine a first reference cell based on the received information. The UE is further configured to determine a second reference cell for performing one or more of blind decode counting and control channel element counting in response to determining that the first reference cell is in a dormant mode. The UE is further configured to perform the one or more of blind decode counting and control channel element counting using the second reference cell.

### CROSS-REFERENCE TO RELATED APPLICATIONS

The present application claims the benefit of U.S. Provisional Patent Application No. 63/531,726, filed on Aug. 9, 2023, which is incorporated by reference herein in its entirety.

### BACKGROUND

### Field

The described aspects generally relate to mechanisms for managing dormant cell(s) within a set of cells for multi-cell scheduling.

### Related Art

A user equipment (UE) can be configured with a set of cells for multi-cell scheduling. For example, the UE can be configured with the set of cells for multi-cell Physical Downlink Shared Channel (PDSCH)/Physical Uplink Shared Channel (PUSCH) scheduling. The network can use a scheduling cell to configure the UE for the set of cells. Additionally, the network can determine (e.g., configure) a reference cell, where the UE can use UE's limited blind decodes and/or control channel elements for decoding a Downlink Control Information (DCI) format on that reference cell. One or more of the cells within the set of cells, one or more of the reference cell(s), and/or one or more of the scheduling cell(s) can be a dormant cell. The cell dormancy can be used as a power saving mechanisms for the UE.

### SUMMARY

Some aspects of this disclosure relate to apparatuses and methods for implementing mechanisms for managing dormant cell(s) within a set of cells for multi-cell scheduling. For example, some aspects of this disclosure are directed to managing scheduling cell(s) and/or reference cell(s) when the reference cell(s) within the set of cells is not a scheduling cell and the reference cell(s) is configured/indicated as dormant/inactive for power saving purpose. Some aspects of this disclosure are directed to managing scheduling cell(s) and/or reference cell(s) when at least one of the co-scheduled cells within the set of cells is configured/indicated as dormant/inactive for power saving.

Some aspects of this disclosure relate to a user equipment (UE). The UE includes a transceiver configured to wirelessly communicate with a base station and a processor communicatively coupled to the transceiver. The processor is configured to receive, using the transceiver, information associated with a set of cells for multi-cell scheduling and determine a first reference cell based on the received information. The processor is further configured to determine a second reference cell for performing one or more of blind decode counting and control channel element counting in response to determining that the first reference cell is in a dormant mode. The processor is further configured to perform the one or more of blind decode counting and control channel element counting using the second reference cell

In some aspects, the processor is further configured to determine that a scheduling cell is within the set of cells and the first reference cell is different from the scheduling cell, disregard the first reference cell, and use the scheduling cell as the second reference cell.

In some aspects, the processor is further configured to determine that a scheduling cell is outside the set of cells and the first reference cell is different from the scheduling cell, disregard the first reference cell, and use a cell within the set of cells with a smallest serving cell index as the second reference cell. In some aspects, the processor is further configured to determine that a scheduling cell is outside the set of cells and disregard the multi-cell scheduling for a duration for which the first reference cell is in the dormant mode.

In some aspects, the processor is further configured to receive, using the transceiver, an indication associated with the second reference cell from the base station. The second reference cell is configured with a search space set for a Downlink Control Information (DCI) format 0_3 or for a DCI format 1_3.

In some aspects, the processor is configured to determine the second reference cell based on the received information.

In some aspects, the processor is further configured to determine that the first reference cell is different from a scheduling cell and disregard the multi-cell scheduling for a duration for which the first reference cell is in the dormant mode. In some aspects, the processor is further configured to refrain from the multi-cell scheduling the UE in response to a ratio of a number of cells in the set of cells in the dormant mode to a number of cells in the set of cell being greater than a threshold.

In some aspects, a co-scheduled cell in the set of cells is in the dormant mode as dormant on an active Bandwidth Part (BWP) and the UE is scheduled on the co-scheduled cell but the UE does not transmit or receive data on the co-scheduled cell. The Downlink Control Information (DCI) size can be determined based on cells of the set of cells and their corresponding active BWPs that are not in the dormant mode.

Some aspects of this disclosure relate to a method including receiving information associated with a set of cells for multi-cell scheduling and determining a first reference cell based on the received information. The method further includes determining a second reference cell for performing one or more of blind decode counting and control channel element counting in response to determining that the first reference cell is in a dormant mode. The method further includes performing the one or more of blind decode counting and control channel element counting using the second reference cell.

Some aspects of this disclosure relate to a non-transitory computer-readable medium storing instructions. When the instructions are executed by a processor, the instructions cause the processor to perform operations including receiving information associated with a set of cells for multi-cell scheduling and determining a first reference cell based on the received information. The operations further include determining a second reference cell for performing one or more of blind decode counting and control channel element counting in response to determining that the first reference cell is in a dormant mode. The operations further include performing the one or more of blind decode counting and control channel element counting using the second reference cell.

Some aspects of this disclosure relate to a base station. The base station includes a transceiver configured to wirelessly communicate with a user equipment (UE) and a processor communicatively coupled to the transceiver. The processor is configured to select a set of cells for multi-cell scheduling, where at least one cell in the set of cells is in a dormant mode. The processor is further configured to determine information associated with a Downlink Control Information (DCI) message based on cells in the set of cells that are in an active mode and transmit, using the transceiver, the DCI message to the UE.

In some aspects, the information associated with the DCI includes a DCI size. In some aspects, the information associated with the DCI includes a size of a common field in DCI messages common between the cells in the set of cells that are in the active mode.

In some aspects, the information associated with the DCI includes a joint field type in the DCI message and the processor is configured to determine the information using an index of a joint table without indicating the at least one cell in the set of cells that is in the dormant mode.

In some aspects, the information associated with the DCI includes a joint field type in the DCI message, the processor is configured to determine the information using an index of a joint table that includes at least one cell in the set of cells that is in the dormant mode, and the UE is configured to ignore values associated with the at least one cell.

In some aspects, the UE is not scheduled for the multi-cell scheduling in response to a ratio of a number of the at least one cell in the set of cells in the dormant mode to a number of cells in the set of cell is greater than a threshold.

Some aspects of this disclosure relate to a method performed by a base station including configuring a user equipment (UE) with a set of cells for multi-cell scheduling, where at least one cell in the set of cells is in a dormant mode. The method further includes determining information associated with a Downlink Control Information (DCI) message based on cells in the set of cells that are in an active mode and transmitting the DCI message to the UE.

Some aspects of this disclosure relate to a non-transitory computer-readable medium storing instructions. When the instructions are executed by a processor of a base station, the instructions cause the base station to perform operations including configuring a user equipment (UE) with a set of cells for multi-cell scheduling, where at least one cell in the set of cells is in a dormant mode. The operations further include determining information associated with a Downlink Control Information (DCI) message based on cells in the set of cells that are in an active mode and transmitting the DCI message to the UE

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing mechanisms for managing dormant cell(s) within a set of cells for multi-cell scheduling, according to some aspects of the disclosure.

FIG. 2 illustrates a block diagram of an example system of an electronic device implementing mechanisms for managing dormant cell(s) within a set of cells for multi-cell scheduling, according to some aspects of the disclosure.

FIG. 3 illustrates an example method for a system (for example, a UE) performing mechanisms for managing dormant cell(s) within a set of cells for multi-cell scheduling, according to some aspects of the disclosure.

FIG. 4 illustrates an example method for a system (for example, a base station) performing mechanisms for managing dormant cell(s) within a set of cells for multi-cell scheduling, according to some aspects of the disclosure.

FIG. 5 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for managing dormant cell(s) within a set of cells for multi-cell scheduling. For example, some aspects of this disclosure are directed to managing scheduling cell(s) and/or reference cell(s) when the reference cell(s) within the set of cells is not a scheduling cell and the reference cell(s) is configured/indicated as dormant/inactive for power saving purpose. Some aspects of this disclosure are directed to managing scheduling cell(s) and/or reference cell(s) when at least one of the co-scheduled cells within the set of cells is configured/indicated as dormant/inactive for power saving.

In some examples, the aspects of this disclosure can be performed by a network and/or a UE that operates according to 5th generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Release 16 (Rel-16), Release 17 (Rel-17), Rel-17 new radio (NR), Rel-18, Rel-18 NR or others. However, the aspects of this disclosure are not limited to these examples, and one or more mechanisms of this disclosure can be implemented by other network(s) and/or UE(s) for managing dormant cell(s) within a set of cells for multi-cell scheduling.

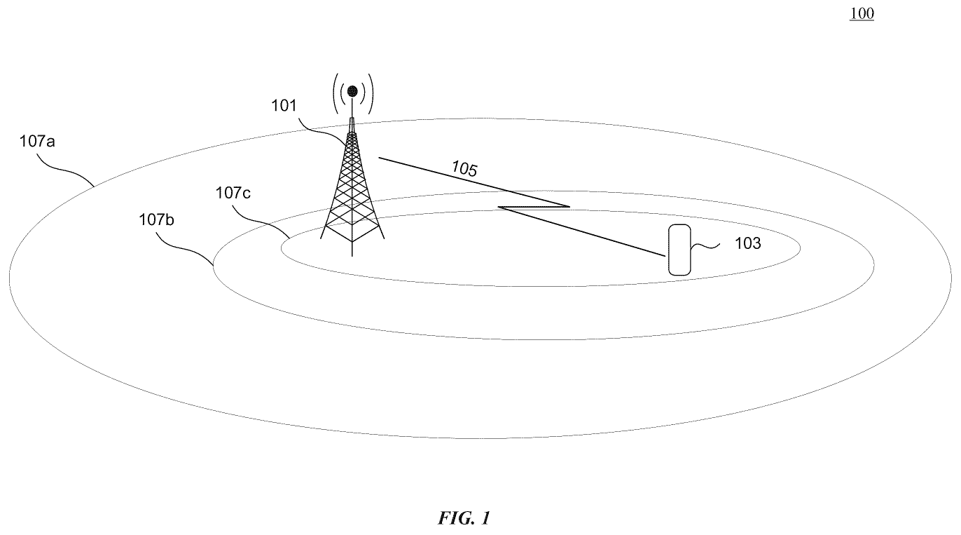

FIG. 1 illustrates an example system 100 implementing mechanisms for managing dormant cell(s) within a set of cells for multi-cell scheduling, according to some aspects of the disclosure. Example system 100 is provided for the purpose of illustration only and does not limit the disclosed aspects.

System 100 may include, but is not limited to, a network node (for example, a base station such as eNBs, gNBs, and the like) 101 and an electronic device (for example, a UE) 103. The UE 103 can be configured to operate based on a wide variety of wireless communication techniques. These techniques can include, but are not limited to, techniques based on 3rd Generation Partnership Project (3GPP) standards. For example, the UE 103 can be configured to operate using Rel-15, Rel-16, Rel-17, Rel-17 NR, Rel-18, Rel-18 NR, or other. The UE 103 can include, but is not limited to, wireless communication devices, smart phones, laptops, desktops, tablets, personal assistants, monitors, televisions, wearable devices, Internet of Things (IoTs), vehicle's communication devices, and the like. The network node 101 (herein referred to as a base station or a cell) can include one or more nodes configured to operate based on a wide variety of wireless communication techniques such as, but not limited to, techniques based on 3GPP standards. For example, the base station 101 can include one or more nodes configured to operate using Rel-15, Rel-16, Rel-17, Rel-17 NR, Rel-18, Rel-18 NR, or others.

According to some aspects, the UE 103 can be connected to and can communicate with the base station 101 using a carrier 105. According to some aspects, the carriers 105 can include one carrier. Additionally, or alternatively, the carrier 105 can include two or more component carriers (CC). In other words, the UE 103 can implement carrier aggregation (CA). For example, the UE 103 can use multiple carriers for communication with the base station 101.

According to some aspects, the base station 101 and the UE 103 are configured to implement mechanisms for managing dormant cell(s) within a set of cells for multi-cell scheduling. For example, the base station 101 and the UE 103 can be configured to manage scheduling cell(s) and/or reference cell(s) when the reference cell(s) within the set of cells is not a scheduling cell and the reference cell(s) is configured/indicated as dormant/inactive for power saving purpose. Additionally, or alternatively, the base station 101 and the UE 103 can be configured to manage scheduling cell(s) and/or reference cell(s) when at least one of the co-scheduled cells within the set of cells is configured/indicated as dormant/inactive for power saving.

In a legacy system, if the base station 101 wanted to configure the UE 103 for multiple different cells (e.g., multiple different PDSCH), the base station 101 had to send multiple different DCI formats. In other words, the base station 101 had to use a different DCI format for each one of the multiple different cells. However, according to some aspects, the base station 101 can schedule the UE 103 for multiple cells (e.g., a set of cells) using one DCI format. For example, the UE 103 can be configured with the set of cells for multi-cell PDSCH and PUSCH scheduling by DCI format 0_3 and/or DCI format ⅓. The UE 103 can be configured with the set of cells for multi-cell PDSCH scheduling by DCI format 1_3. The UE 103 can be configured with the set of cells for multi-cell PUSCH scheduling by DCI format 0_3. Herein, DCI format “0_3/1_3” is used for DCI format 0_3, DCI format 1_3, or both.

According to some aspects, the set of cells can include cells 107a, 107b, and 107c. Although three cells 107a-107c are illustrated, the aspects of this disclosure are not limited to this example and the set of cells can include any number of cells. Also, although the cells 107a-107c are illustrated as cells associated with the base station 101, the cells 107a-107c can be associated with one base station or can be associated with two or more base stations. The cells 107a-107c of the set of cells can include Primary cell (PCell) and/or Secondary cell (SCell).

According to some aspects, the network (e.g., the base station 101 and/or the system 100) can use a scheduling cell to configure the UE 103 for the set of cells (that include the cells 107a-107c). A scheduling cell can be a cell used by the network (e.g., the base station 101 and/or the system 100) to configure (e.g., schedule) the UE on the set of cells. According to some aspects, the set of cells can include a maximum of four cells. However, the aspects of this disclosure are not limited to this example, and the set of cells can include other number of maximum of cells. Although the set of cells can include a maximum number of cells, the dynamic scheduling can include a subset of the set of cells.

The scheduling cell can be a PCell or a SCell. The scheduling cell can be an SCell if all the co-scheduled cells are also SCells. According to some aspects, the SCell is allowed to schedule SCell(s) but the SCell is not allowed to schedule a PCell. If the scheduling cell is a PCell, the scheduling cell can schedule SCell(s) and/or PCell(s).

The UE 103 can use blind decoding when the UE receives a DCI format from the base station 101 on the PDCCH. The UE 103 can be configured with a set of parameters. The UE 103 can use a blind search of the combination of the parameters to decode the DCI format. According to some aspects, the UE 103 has a budget (e.g., a maximum number) of blind decodes (BDs) and/or control channel elements (CCEs) for decoding the received DCI format. When a set of cells (e.g., the set of cells including the cells 107a-107c) is being scheduled, the UE 103 cannot blind decode on each cell of the set of cells that is being scheduled. Therefore, a reference cell is determined (e.g., configured), where the UE 103 can use its limited blind decodes and/or control channel elements for decoding the DCI format on that reference cell. The reference cell is used for BD/CCE counting budget for the DCI format 0_3/1_3. According to some aspects, the base station 101 can configure/determine the reference cell for the UE's BD/CCE counting budget.

According to some aspect, if the scheduling cell is within the set of cells, the reference cell can be either the scheduling cell or other cell(s) within the set can be configured as the reference cell. If the scheduling cell is outside the set of cells, one cell within the set can be configured as the reference cell.

According to some aspects, cell dormancy (e.g., SCell dormancy) is used as a power saving mechanisms for the UE 103. The UE 103 can be associated to a plurality of SCells. In order for the UE 103 to save energy, one or more of the plurality of SCells can be placed in a dormant mode. When an SCell is activated, the UE 103 can be expected to perform link quality measurements, reporting, control channel monitoring, or the like on that SCell. When the SCell is the dormant mode (e.g., the SCell is inactive), the UE 103 does not monitor the SCell (e.g., the UE 103 does monitor the control channel on the SCell). Additionally, or alternatively, when the SCell is the dormant mode (e.g., the SCell is inactive), the UE 103 does not actively transmit on the SCell. For example, the SCell can be put in the dormant mode, where UE does not monitor PDCCH. In some examples, the Channel State Information (CSI) or Radio Resource Management (RRM) measurement can still be performed. In some examples, the dormancy can be applied to Bandwidth Part (BWP) level as well within a SCell.

The UE 103 can be configured with one or multiple SCell groups for dormancy. Each SCell group can contain one or multiple SCells. If a SCell is indicated as dormant, that SCell cannot be scheduled and cannot be use for scheduling other cells.

According to some aspects, the network (e.g., the base station 101) can communicate the SCell dormancy to the UE 103 using a DCI field (e.g., a DCI field in the DCI format 0_3/1_3.) For example, a field such as a SCell dormancy indication field can be used to communicate the SCell dormancy to the UE 103. The SCell dormancy indication field has a length of 0 bit (the SCell dormancy indication field is not used) if higher layer parameter dormancyGroupWithinActiveTime is not configured. If the higher layer parameter dormancyGroupWithinActive Time is configured, the SCell dormancy indication field can be a 1, 2, 3, 4 or 5 bits bitmap determined according to the number of different DormancyGroupID(s) provided by the higher layer parameter dormancyGroup WithinActiveTime. Each bit corresponds to one of the SCell group(s) configured by the higher layers parameter dormancyGroupWithinActiveTime, with most significant bit (MSB) to least significant bit (LSB) of the bitmap corresponding to the first to last configured SCell group in ascending order of DormancyGroupID. According to some aspects, the SCell dormancy indication field is only present when this format is carried by PDCCH on the PCell within Discontinuous Reception (DRX) Active Time and the UE 103 is configured with at least two downlink (DL) BWPs for an SCell.

According to some aspects, the base station 101 and the UE 103 can be configured to manage scheduling cell(s) and/or reference cell(s) when the reference cell(s) within the set of cells is not a scheduling cell and the reference cell(s) is configured/indicated as dormant/inactive for power saving purpose. Additionally, or alternatively, the base station 101 and the UE 103 can be configured to manage scheduling cell(s) and/or reference cell(s) when at least one of the co-scheduled cells within the set of cells is configured/indicated as dormant/inactive for power saving.

According to some aspects, the UE 103 is being configured for multi-cell scheduling. For example, the base station 101 can configure the UE 103 for multi-cell scheduling. According to some aspects, the UE 101 can be configured with a reference cell within the set of cells for the multi-cell scheduling. The reference cell is not the scheduling cell, and the scheduling cell is within the set of cells. In this example, the reference cell is configured/indicated as dormant on the active BWP. According to some aspects, the base station 101 can indicate to the UE 103 which cell is the reference cell, which cell is the scheduling cell, and that the reference cell is configured/indicated as dormant. The UE 103 is configured to disregard the reference cell. The UE 103 is further configured to use the scheduling cell as the reference cell. Therefore, the UE can use the scheduling cell as the reference cell for BD/CCE and DCI size counting for DCI format 0_3/1_3. In other words, since the UE 103 is receiving the DCI format 0_3/1_3 from the base station 101 on the scheduling cell, and since the reference cell is configured/indicated as dormant, the UE can perform the BD/CCE and DCI size counting for the DCI format 0_3/1_3 on the scheduling cell.

According to some aspects, the UE 103 can be configured with the reference cell within the set of cells for the multi-cell scheduling. The reference cell is not the scheduling cell, the scheduling cell is outside the set of cells and, and the reference cell is configured/indicated as dormant on the active BWP. According to some aspects, the base station 101 can indicate to the UE 103 which cell is the reference cell, which cell is the scheduling cell, and that the reference cell is configured/indicated as dormant. According to some aspect, the scheduling cell that is outside the set of cells cannot be the reference cell because the reference cell is to be within the set of cells. In this example, the UE 103 is configured to disregard the reference cell. The UE 103 is further configured to use a serving cell with the smallest serving cell index as the reference cell and the BD/CCE and DCI size counting for DCI format 0_3/1_3 is done on that serving cell with the smallest index. In some implementations, the smallest service cell index that is assumed to be the reference cell can be configured with search space set for DCI format 0_3/1_3.

In a non-limiting example, the set of cells can include cell 1 107a, cell 2 107b, and cell 3 107c. Assuming that the cell 3 107c is the reference cell that is configured/indicated as dormant, the base station 101 can use the cell with the smallest serving cell index (e.g. the cell 1 107a) as the reference cell. In another non-limiting example, the cell 1 107a is not configured with the search space set for the DCI format 0_3/1_3 but the cell 2 107b is configured with the search space set for the DCI format 0_3/1_3. In this example, the base station 101 can use the cell with the smallest serving cell index that is configured with the search space set for the DCI format 0_3/1_3 (e.g. the cell 1 107b) as the reference cell.

According to some aspects, the UE 103 can be configured with the reference cell within the set of cells for multi-cell scheduling and the reference cell is configured/indicated as dormant on the active BWP. In this example, the base station 101 can dynamically configure another cell from the set of cells as a reference cell. For example, the base station 101 can use a field in the DCI format 0_3/1_3 to indicate to the UE 103 a cell index of another cell to be used as the reference cell. The base station 101 can use other signals to indicate another cell to be used as the reference cell. In one implementation, the another cell can be dynamically configured as the reference cell and can be configured with search space set for DCI format 0_3/1_3. For example, the base station 101 can use a field in the DCI format 0_3/1_3 to indicate to the UE 103 a cell index of another cell that has the search space set for DCI format 0_3/1_3 that is to be used as the reference cell.

According to some aspects, if the UE 103 is capable of multi-cell scheduling, then UE 103 can be configured with more than one reference cell for the set of cells where at least one of the configured reference cells is a default reference cell (or alternatively assigned with highest priority). In other words, the base station 101 can indicate to the UE 103 that two or more cells of the set of cells are configured as the reference cells. If the default reference cell is dormant, then the UE 103 can use the other configured reference cell(s) for BD/CCE and DCI budget counting. In a non-limiting example, the set of cells can include cell 1 107a, cell 2 107b, and cell 3 107c. The base station 101 can indicate (using, for example, DCI format 0_3/1_3 or other signals) to the UE 103 that the cell 1 107a and the cell 2 107b are the reference cells. Therefore, if the cell 1 107a is dormant, then the UE 103 can use the cell 2 107b as the reference cell.

According to some aspects, the UE 103 can be configured with the reference cell within the set of cells for the multi-cell scheduling. The reference cell is not the scheduling cell and the reference cell is configured/indicated as dormant on the active BWP. According to some aspects, the base station 101 can indicate to the UE 103 which cell is the reference cell and that the reference cell is configured/indicated as dormant. In this example, the UE 103 is not expected to be scheduled for the multi-cell scheduling for the duration for which the reference cell is dormant/inactive. In some implementations, the cells in the set of cell (other than the reference cell) can still be scheduled using legacy single-cell scheduling DCI formats.

According to some aspects, the UE 103 can be configured with the set of cells for the multi-cell scheduling and one of the co-scheduled cells in the set of cells is configured/indicated as dormant on the active BWP. In this example, the UE can be scheduled on the dormant cell but the UE 103 is not expected to transmit or receive data on the dormant cell. In other words, the base station 101 can schedule the UE 103 on the set of cells including the dormant cell. But the UE 103 will not transmit or receive data on the dormant cell knowing that the cell is in dormant mode.

According to some aspects, one or more sets of cells are available to the base station 101 to choose for configuring the UE 103 for multi-cell scheduling. For example, the base station 101 can choose from a first set of cells (cell 1 107a, cell 2 107b, and cell 3 107c), a second set of cells (cell 1 107a and cell 3 107c), and a third set of cells (cell 2 107b and cell 3 107c) for configuring the UE 103. The base station 101 can choose the first set of cells (cell 1 107a, cell 2 107b, and cell 3 107c) for configuring the UE 103 for multi-cell scheduling. The base station 101 can send a message (e.g., a DCI format) to the UE 103 to configure the UE 103 for multi-cell scheduling with the first set of cells (cell 1 107a, cell 2 107b, and cell 3 107c). In this example, if the cell 2 107b is in dormant mode, both the base station 101 and the UE 103 know that the cell 2 107b is in dormant mode. So, the UE 103 will be scheduled on the first set of cells (cell 1 107a, cell 2 107b, and cell 3 107c) but the UE 103 is not expected to transmit or receive data on the dormant cell 2 107b.

In this example, the DCI size is determined based on the cells and corresponding active BWPs that are not dormant. For example, the base station 101 can determine the DCI size based on the cells and corresponding active BWPs that are not dormant. In the non-limiting example discussed above, the base station 101 can determine the DCI size based on DCI formats on the cell 1 107a and the cell 3 107c because the cell 2 107b is a dormant cell.

In this example, the size of each of the common field type in the DCI can be determined without taking into account that field for the cell and corresponding BWPs that are dormant. For example, if an antenna port indication field is configured as a common field type, then the size of field is based on the maximum size among the cells that are not dormant. In the non-limiting example discussed above, if the antenna port indication field for the cell 1 107a is 4 bits, the antenna port indication field for the cell 2 107b is 6 bits, and the antenna port indication field for the cell 3 107c is 5 bits, the base station 101 can choose the maximum size of 5 bits, that is the maximum size among the cells that are not dormant (the cell 1 107a and the cell 3 107c).

In this example, for joint field type in the DCI, one of two options can be applied in case a co-schedule cell is dormant. The joint field type can be associated with a combination of different values for different cells in the set of cells. According to some aspects, the joint field type can be an index to a joint table that includes the combination of different values for different cells in the set of cells. According to some aspects, the joint table can be stored (e.g., pre-stored) in UE 103. Additionally, or alternatively, the base station 101 can send the joint table to the UE 103. The base station 101 can use one of the following options for joint field type. In Option 1, the base station 101 can only indicate the index of the joint table, where the joint table is constructed without the dormant cell. In the non-limiting example discussed above, the base station 101 can indicate the index of the joint table without the cell 2 107b. For example, the base station 101 can indicate the index of the joint table that points to rows associated with the cell 1 107a and the cell 3 107c. In Option 2, the joint table includes a dormant cell and if the index of the joint table indicates the dormant cell, then the values for the dormant cell are ignored by the UE 103 and only the values for other non-dormant cells are applied by the UE 103.

In this example, for Hybrid Automatic Repeat Request (HARQ) Acknowledgment (HARQ-ACK) timing, a scheduled PDSCH on dormant cells is not considered as a reference PDSCH. In some aspect, the HARQ-ACK is a feedback that the UE 103 can send to the base station 101 for each cell. When multiple cells are used (e.g., the set of cells), the UE 103 can use the last PDSCH (e.g., the PDSCH with data received at the UE 103 the last between the PDSCHs on the set of cells) as the reference PDSCH. The UE 103 will not consider the scheduled PDSCH on dormant cells as the reference PDSCH. Therefore, the UE 103 will not use the scheduled PDSCH on dormant cells for HARQ-ACK timing. If the scheduled PDSCH on dormant cells is the PDSCH with data received the last between the PDSCHs on the set of cells, the UE 103 will use the next to the last PDSCH as the reference PDSCH for HARQ-ACK timing.

Similarly, for Downlink Assignment Indicator (DAI) counting, a scheduled PDSCH on dormant cells is not considered as reference PDSCH. In other words, the UE 103 will not consider the scheduled PDSCH on dormant cells as the reference PDSCH for DIA counting. If the scheduled PDSCH on dormant cells is the PDSCH with data received the last between the PDSCHs on the set of cells, the UE 103 will use the next to the last PDSCH as the reference PDSCH for DAI counting.

According to some aspects, the UE 103 is configured with the set of cells for multi-cell scheduling and N cells from a set with M cells are configured/indicated as dormant on their respective active BWPs. In this example, N and M are non-negative integer numbers of N is equal to or smaller than M. According to some aspects, the UE 103 is not expected to be scheduled for multi-cell scheduling for the set of cells, if the ratio of N/M is above a threshold. The threshold can be set by the network (e.g., the base station 101). The threshold can be communicated from the base station 101 to the UE 103 and/or can be stored at the UE 103. In some aspects, the threshold can be a dynamic threshold and can be changed by the network depending on, for example, the number of cells in the set of cells, the quality of communication on different cells, and the like.

If the ratio of N/M is less than or equal to the threshold, then one or more exemplary implementations discussed herein can be used.

In a non-limiting example, if 3 cells are configured within the set of cells, and if 2 of the 3 cells are dormant, then UE 103 is not expected to be co-scheduled with multi-cell scheduling for those dormant cells. However, the number of cell in the set of cell and the threshold are not limited to this example and can include any other values.

Although some exemplary implementations are discussed, it is noted that the aspects of this disclosure can include any combination of these implementations.

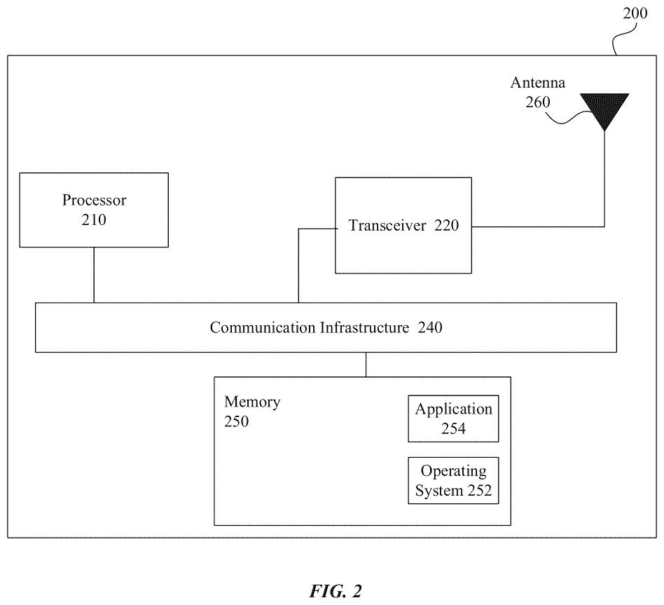

FIG. 2 illustrates a block diagram of an example system 200 of an electronic device implementing mechanisms for managing dormant cell(s) within a set of cells for multi-cell scheduling, according to some aspects of the disclosure. System 200 may be any of the electronic devices (e.g., base station 101, UE 103) of system 100. System 200 includes a processor 210, one or more transceivers 220, a communication infrastructure 240, a memory 250, operating system 252, application 254, and/or one or more antennas 260. Illustrated systems are provided as exemplary parts of system 200, and system 200 can include other circuit(s) and subsystem(s). Also, although system 200 is illustrated with separate components, the aspects of this disclosure can include any combination of these, less, or more components. Also, system 200 of the aspects of this disclosure can include any number of processors, transceivers, communication infrastructures, memories, operating systems, applications, and antennas.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in memory 250. The operating system 252 can manage transfer of data between the memory 250, one or more applications 254, the processor 210, and/or one or more transceivers 220. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by wireless system 200 and/or a user of wireless system 200. The applications in the application 254 can include applications such as, but not limited to, radio streaming, video streaming, remote control, and/or other user applications.

System 200 can also include the communication infrastructure 240. The communication infrastructure 240 provides communication between, for example, the processor 210, the one or more transceivers 220, and the memory 250. In some implementations, the communication infrastructure 240 may be a bus. The processor 210 together with instructions stored in memory 250 performs operations enabling system 200 of system 100 to implement mechanisms for managing dormant cell(s) within a set of cells for multi-cell scheduling, as described herein.

The one or more transceivers 220 transmit and/or receive communications signals that support the operations of system 200 including, but not limited to, mechanisms for managing dormant cell(s) within a set of cells for multi-cell scheduling, according to some aspects, and may be coupled to the one or more antennas 260. The one or more antennas 260 may include one or more antennas that may be the same or different types. The one or more antennas 260 may include one or more MIMO antenna(s) having one or more antenna ports. According to some aspects, each antenna port of the one or more antennas 260 can carry its resource grid and one or more reference signals. The antenna ports of the one or more antennas 260 can be indicated using port numbers. Different antenna ports can be assigned to different channels and/or signals.

The one or more transceivers 220 allow system 200 to communicate with other devices that may be wired and/or wireless. In some examples, the one or more transceivers 220 can include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects, the one or more transceivers 220 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220 can include more or fewer systems for communicating with other devices.

In some examples, the one or more transceivers 220 can include one or more circuits (including a WLAN transceiver) to enable connection(s) and communication over WLAN networks such as, but not limited to, networks based on standards described in IEEE 802.11. Additionally, or alternatively, the one or more transceivers 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, the one or more transceivers 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220a-220n can be configured to operate according to one or more of Rel-15, Rel-16, Rel-17, Rel-17 NR, Rel-18, Rel-18 NR, or other of the 3GPP standards.

According to some aspects, the processor 210, alone or in combination with computer instructions stored within the memory 250, and/or the one or more transceiver 220, implements mechanisms for managing dormant cell(s) within a set of cells for multi-cell scheduling, as discussed herein.

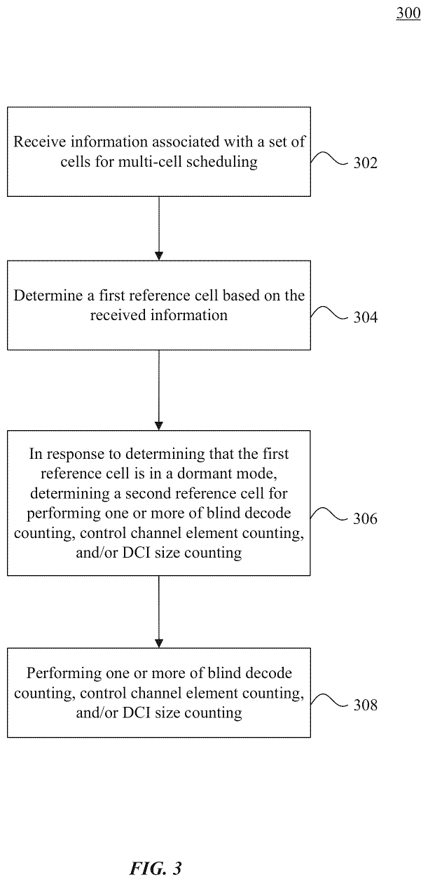

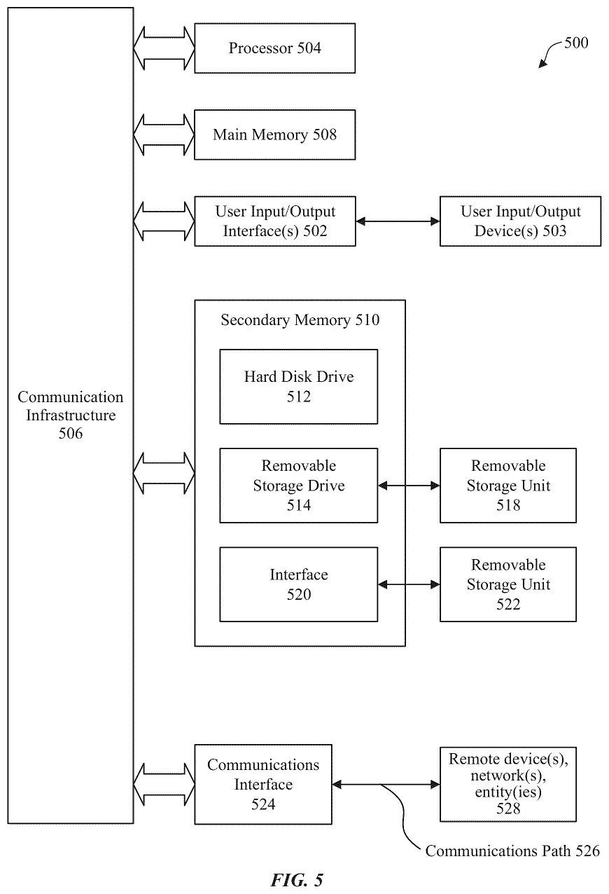

FIG. 3 illustrates an example method 300 for a system (for example, a UE) performing mechanisms for managing dormant cell(s) within a set of cells for multi-cell scheduling, according to some aspects of the disclosure. As a convenience and not a limitation, FIG. 3 may be described with regard to elements of FIGS. 1-2. Method 300 may represent the operation of an electronic device (for example, UE 103 of FIG. 1) implementing mechanisms for managing dormant cell(s) within a set of cells for multi-cell scheduling. Method 300 may also be performed by system 200 of FIG. 2 and/or computer system 500 of FIG. 5. For example, processor 210 may perform, or cause system 200 to perform, the functions of method 500. But method 300 is not limited to the specific aspects depicted in those figures and other systems may be used to perform the method as will be understood by those skilled in the art. It is to be appreciated that not all operations may be needed, and the operations may not be performed in the same order as shown in FIG. 3.

At 302, information associated with a set of cells for multi-cell scheduling is received. For example, a UE (e.g., the UE 103) can receive information associated with the set of cells for multi-cell scheduling. The UE can receive the information from a base station (e.g., the base station 101). According to some aspects, the UE can receive the information from the base station using a DCI message. For example, the UE can receive the information through a DCI format 0_3 and/or a DCI format 1_3. However, the aspects of this disclosure are not limited to these examples, and the UE can receive the information associated with the set of cells for multi-cell scheduling through other signals from the base station.

According to some aspects, the information associated with the set of cells for multi-cell scheduling can include an indication (e.g., an index) of a scheduling cell that is used for scheduling the set of cells. Additionally, or alternatively, the information associated with the set of cells for multi-cell scheduling can include indications (e.g., indexes) for the cells within the set of cells. Additionally, or alternatively, the information associated with the set of cells for multi-cell scheduling can include an indication (e.g., an index) of a first reference cell. Additionally, or alternatively, the information associated with the set of cells for multi-cell scheduling can include information (e.g., indexes, bitmap, and the like) for dormant cell(s). The information associated with the set of cells for multi-cell scheduling can include other information and parameters for the set of cells.

At 304, a first reference cell is determined based on the received information. For example, the UE can determine the first reference cell using the information the UE received from the base station. As discussed above, the UE can use the first reference cell for BD counting budget, for CCE counting budget, and/or for DCI size counting. For example, the UE can perform BD counting budget, CCE counting budget, and/or DCI size counting for DCI format 0_3/1_3 on the first reference cell.

At 306, in response to determining that the first reference cell is in a dormant mode, the UE can determine a second reference cell. The UE can determine the second reference cell for performing one or more of BD counting budget, CCE counting budget, and/or DCI size counting. According to some aspects, the UE can use the information received from the base station in step 302 to determine that the first reference cell is a dormant cell (is in the dormant mode). For example, the information associated with the set of cells for multi-cell scheduling received in step 302 can include information (e.g., indexes, bitmap, and the like) for dormant cell(s).

According to some aspects, the UE can determine that a scheduling cell is within the set of cells and the first reference cell is different from the scheduling cell. For example, using the received information from the base station, the UE can determine that the scheduling cell is within the set of cells, the first reference cell is different from the scheduling cell, and the first reference cell is in the dormant mode. The UE can then disregard the first reference cell and can use the scheduling cell as the second reference cell. In this example, the UE can determine the second reference cell to be the scheduling cell.

According to some aspects, the UE can determine that a scheduling cell is outside the set of cells and the first reference cell is different from the scheduling cell. For example, using the received information from the base station, the UE can determine that the scheduling cell is outside the set of cells, the first reference cell is different from the scheduling cell, and the first reference cell is in the dormant mode. The UE can then disregard the first reference cell and use a cell within the set of cells with a smallest serving cell index as the second reference cell. In this example, the UE can determine the second reference cell to be the cell within the set of cells with a smallest serving cell index. According to some aspects, the cell indexes are part of the information received at step 302.

According to some aspects, using the received information from the base station, the UE can determine that the scheduling cell is outside the set of cells and the first reference cell is in the dormant mode. In some examples, the first reference cell is different from the scheduling cell. In response to the scheduling cell being outside the set of cells and the first reference cell being in the dormant mode, the UE can disregard the multi-cell scheduling. For example, the UE can disregard the multi-cell scheduling for a duration for which the first reference cell is in the dormant mode.

According to some aspects, the reference cells can be dynamically configured by the network (e.g., by the base station). In these examples, the UE can receive an indication (e.g., an index) for the second reference cell from the base station. The UE can then determine the second reference cell and use the second reference cell for performing one or more of BD counting budget, CCE counting budget, and/or DCI size counting. In some examples, the second reference cell is configured with a search space set for a DCI format 0_3 and/or for a DCI format 1_3.

According to some aspects, the UE is configured to determine the second reference cell based on the received information. The UE can be configured with more than one reference cell for the set of cell. For example, the UE can be configured with the first reference cell and the second reference cell. Information (e.g., indications such as indexes) associated with the first and second reference cells can be included in the information received at step 302. In some examples, the first reference cell can be a default (or alternatively assigned with highest priority) reference cell. When the UE determines that the first reference cell is in the dormant mode, then the UE can determine and use the second reference cell.

According to some aspects, the UE determines that the first reference cell is different from a scheduling cell and the first reference cell is in the dormant mode. Then, the UE can disregard the multi-cell scheduling for a duration for which the first reference cell is in the dormant mode. In some implementations, the cells in the set of cell (other than the first reference cell) can still be scheduled using legacy single-cell scheduling DCI formats.

At 308, one or more of the blind decode counting and the control channel element counting are performed using the second reference cell. The UE can use the determined second reference cell to perform the BD counting budget, the CCE counting budget, and/or the DCI size counting. The UE can use one or more of the scheduled cells to communicate with the base station.

According to some aspects, the UE is not scheduled for the multi-cell scheduling in response to a ratio of a number of cells in the set of cells in the dormant mode to a number of cells in the set of cell is greater than a threshold.

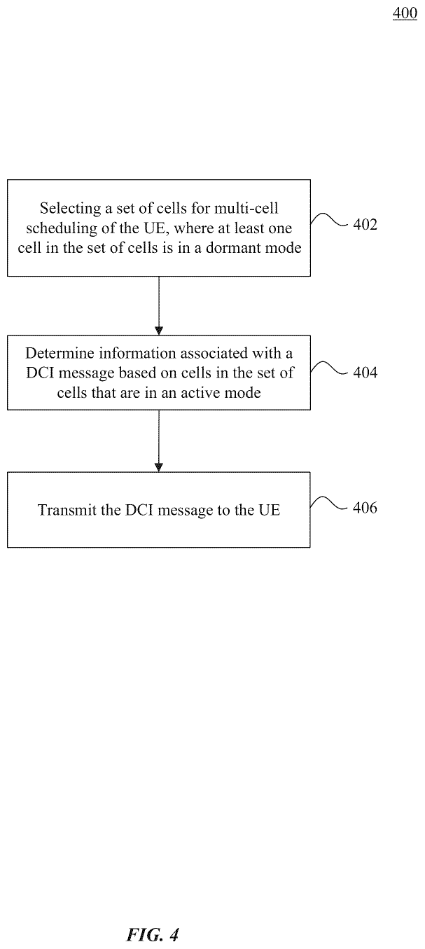

FIG. 4 illustrates an example method 400 for a system (for example, a base station) performing mechanisms for managing dormant cell(s) within a set of cells for multi-cell scheduling, according to some aspects of the disclosure. As a convenience and not a limitation, FIG. 4 may be described with regard to elements of FIGS. 1-3. Method 400 may represent the operation of an electronic device (for example, base station 101 of FIG. 1) performing mechanisms for managing dormant cell(s) within a set of cells for multi-cell scheduling. Method 400 may also be performed by system 200 of FIG. 2 and/or computer system 500 of FIG. 5. For example, processor 210 may perform, or cause system 200 to perform, the functions of method 500. But method 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

At 402, a UE is configured with a set of cells for multi-cell scheduling, where at least one cell in the set of cells is in a dormant mode. For example, a base station (e.g., the base station 101) is configured to select a set of cells for multi-cell scheduling for the UE. In this example, the UE can be scheduled on the dormant cell but the UE is not expected to transmit or receive data on the dormant cell. In other words, the base station can schedule the UE on the set of cells including the dormant cell. But the UE will not transmit or receive data on the dormant cell knowing that the cell is in dormant mode.

According to some aspects, the base station has one or more sets of cells that available to be selected for configuring the UE for multi-cell scheduling. For example, the base station can select from a first set of cells, a second set of cells, and a third set of cells for configuring the UE. In a non-limiting example, the base station selects the first set of cells for configuring the UE for multi-cell scheduling. In this example, if a cell in the first set of cells is in the dormant mode, both the base station and the UE know that the cell is in the dormant mode. So, the UE will be scheduled on the first set of cells but the UE is not expected to transmit or receive data on the dormant cell.

At 404, information associated with a Downlink Control Information (DCI) message is determined based on cells in the set of cells that are in an active mode. For example, the base station determines information associated with the DCI message based on cells in the set of cells that are in an active mode (e.g., not in the dormant mode).

According to some aspects, the information associated with the DCI includes a DCI size. For example, the base station can determine the DCI size based on the cells and corresponding active BWPs that are not in the dormant mode. In the non-limiting example discussed above, the base station can determine the DCI size based on DCI formats on the cells of the first set of cell except for the dormant cell. In some examples, the base station can determine the DCI size based on a maximum of DCI sizes on the cells and corresponding active BWPs that are not in the dormant mode. In some examples, the base station can determine the DCI size based on a minimum of DCI sizes on the cells and corresponding active BWPs that are not in the dormant mode. In some examples, the base station can determine the DCI size based on an average of DCI sizes on the cells and corresponding active BWPs that are not in the dormant mode. Other methods can be used to determine the DCI size based on the DCI sizes on the cells and corresponding active BWPs that are not in the dormant mode.

According to some aspects, the information associated with the DCI includes a size of a common field in DCI messages common between the cells in the set of cells that are in the active mode (e.g., not in the dormant mode). For example, the base station can determine the size of each of the common field type in the DCI message without taking into account that field for the cell and corresponding BWPs that are dormant. For example, if an antenna port indication field is configured as a common field type, then the size of field is based on the maximum size among the cells that are not dormant. In some examples, the base station can determine the size of the common field in DCI message based on a maximum of sizes of the common field in DCI messages on the cells and corresponding active BWPs that are not in the dormant mode. In some examples, the base station can determine the size of the common field in DCI message based on a minimum of sizes of the common field in DCI messages on the cells and corresponding active BWPs that are not in the dormant mode. In some examples, the base station can determine the size of the common field in DCI message based on an average of sizes of the common field in DCI messages on the cells and corresponding active BWPs that are not in the dormant mode. Other methods can be used to determine the size of the common field in DCI message based on the sizes of the common field in DCI messages on the cells and corresponding active BWPs that are not in the dormant mode.

According to some aspects, the information associated with the DCI includes a joint field type in the DCI message and the base station is configured to determine the information using an index of a joint table without indicating the at least one cell in the set of cells that is in the dormant mode. Additionally, or alternatively, the base station is configured to determine the information using an index of a joint table with indicating the at least one cell in the set of cells that is in the dormant mode, and the UE is configured to ignore values associated with the at least one cell.

For example, for a joint field type in the DCI message, one of the two options can be applied when a co-scheduled cell is dormant. The joint field type can be associated with a combination of different values for different cells in the set of cells. According to some aspects, the joint field type can be an index to a joint table that includes the combination of different values for different cells in the set of cells. The base station can only indicate the index of the joint table, where the joint table is constructed without the dormant cell. For example, the base station can send the index of the joint table without the dormant cell to the UE using the DCI message. Additionally, or alternatively, the joint table includes a dormant cell and if the index of the joint table indicates the dormant cell, then the values for the dormant cell are ignored by the UE and only the values for other non-dormant cells are applied by the UE. For example, the base station can send the index of the joint table with dormant cell to the UE. The UE can ignore the values for the dormant cell and only use the values for other non-dormant cells.

At 406, the DCI message is transmitted to the UE. For example, the base station can transmit the DCI message to the UE. The DCI message can include the information determined in step 404. The base station can send the DCI message to the UE to configure the UE 103 for multi-cell scheduling.

According to some aspects, the UE is not scheduled for the multi-cell scheduling in response to a ratio of a number of the at least one cell in the set of cells in the dormant mode to a number of cells in the set of cell is greater than a threshold.

Various aspects can be implemented, for example, using one or more computer systems, such as computer system 500 shown in FIG. 5. Computer system 500 can be any computer capable of performing the functions described herein such as devices 101, 103 of FIG. 1, and/or 200 of FIG. 2. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to wirelessly communicate with a base station; and
a processor communicatively coupled to the transceiver and configured to:
receive, using the transceiver, information associated with a set of cells for multi-cell scheduling;
determine a first reference cell based on the received information;
in response to determining that the first reference cell is in a dormant mode, determine a second reference cell for performing one or more of blind decode counting and control channel element counting; and
perform the one or more of blind decode counting and control channel element counting using the second reference cell.

2. The UE of claim 1, wherein the processor is further configured to:
determine that a scheduling cell is within the set of cells and the first reference cell is different from the scheduling cell;
disregard the first reference cell; and
use the scheduling cell as the second reference cell.

3. The UE of claim 1, wherein the processor is further configured to:
determine that a scheduling cell is outside the set of cells and the first reference cell is different from the scheduling cell;
disregard the first reference cell; and
use a cell within the set of cells with a smallest serving cell index as the second reference cell.

4. The UE of claim 1, wherein the processor is further configured to:
determine that a scheduling cell is outside the set of cells; and
disregard the multi-cell scheduling for a duration for which the first reference cell is in the dormant mode.

5. The UE of claim 1, wherein the processor is further configured to receive, using the transceiver, an indication associated with the second reference cell from the base station.

6. The UE of claim 5, wherein the second reference cell is configured with a search space set for a Downlink Control Information (DCI) format 0_3 or for a DCI format 1_3.

7. The UE of claim 1, wherein the processor is configured to determine the second reference cell based on the received information.

8. The UE of claim 1, wherein the processor is further configured to:
determine that the first reference cell is different from a scheduling cell; and
disregard the multi-cell scheduling for a duration for which the first reference cell is in the dormant mode.

9. The UE of claim 1, wherein:
a co-scheduled cell in the set of cells is in the dormant mode as dormant on an active Bandwidth Part (BWP),
the UE is scheduled on the co-scheduled cell but the UE does not transmit or receive data on the co-scheduled cell, and
a Downlink Control Information (DCI) size is determined based on cells of the set of cells and their corresponding active BWPs that are not in the dormant mode.

10. A method, comprising:
receiving information associated with a set of cells for multi-cell scheduling;
determining a first reference cell based on the received information;
in response to determining that the first reference cell is in a dormant mode, determining a second reference cell for performing one or more of blind decode counting and control channel element counting; and
performing the one or more of blind decode counting and control channel element counting using the second reference cell.

11. The method of claim 10, further comprising:
determining that a scheduling cell is within the set of cells and the first reference cell is different from the scheduling cell;
disregarding the first reference cell; and
using the scheduling cell as the second reference cell.

12. The method of claim 10, further comprising:
determining that a scheduling cell is outside the set of cells and the first reference cell is different from the scheduling cell;
disregarding the first reference cell; and
using a cell within the set of cells with a smallest serving cell index as the second reference cell.

13. The method of claim 10, further comprising receiving an indication associated with the second reference cell from the base station.

14. The method of claim 10, further comprising determining the second reference cell based on the received information.

15. The method of claim 10, further comprising:
determine that the first reference cell is different from a scheduling cell; and
disregard the multi-cell scheduling for a duration for which the first reference cell is in the dormant mode.

16. The method of claim 10, further comprising refraining from the multi-cell scheduling a user equipment (UE) in response to a ratio of a number of cells in the set of cells in the dormant mode to a number of cells in the set of cell being greater than a threshold.

17. The method of claim 10, wherein:
a co-scheduled cell in the set of cells is in the dormant mode as dormant on an active Bandwidth Part (BWP),
a user equipment (UE) is scheduled on the co-scheduled cell but the UE does not transmit or receive data on the co-scheduled cell, and
a Downlink Control Information (DCI) size is determined based on cells of the set of cells and their corresponding active BWPs that are not in the dormant mode.

18. A base station, comprising:
a transceiver configured to wirelessly communicate with a user equipment (UE); and
a processor communicatively coupled to the transceiver and configured to:
select a set of cells for multi-cell scheduling, wherein at least one cell in the set of cells is in a dormant mode;
determine information associated with a Downlink Control Information (DCI) message based on cells in the set of cells that are in an active mode; and
transmit, using the transceiver, the DCI message to the UE.

19. The base station of claim 18, wherein the information associated with the DCI comprises a joint field type in the DCI message and the processor is configured to determine the information using an index of a joint table without indicating the at least one cell in the set of cells that is in the dormant mode.

20. The base station of claim 18, wherein the information associated with the DCI comprises a joint field type in the DCI message, wherein the processor is configured to determine the information using an index of a joint table that includes at least one cell in the set of cells that is in the dormant mode, and wherein the UE is configured to ignore values associated with the at least one cell.
